(19) United States
(12) Patent Application Publication
(10) Pub. No.: US 2022/0198541 A1
(43) Pub. Date: Jun. 23, 2022

(54) COMPUTING APPARATUS FOR PROVIDING ITEM SALES INFORMATION AND METHOD THEREOF

(71) Applicant: Coupang Corp., Seoul (KR)

(72) Inventors: Seon Il Kim, Seoul (KR); Seung Hee Kang, Seoul (KR); Hyun Gyu Jang, Seoul (KR); Hae Yeon Lee, Seoul (KR); Nam Woong Cho, Seoul (KR); Hong Gwi Joo, Seoul (KR); Tianzhu Ma, Seoul (KR); Ming Zhang, Seoul (KR); Qingqing Bai, Seoul (KR); Sang Ryul Kim, Seoul (KR); Pil Woo Kim, Seoul (KR); Tae Hoon Kim, Seoul (KR); Ku Kang, Seoul (KR); Prakash Kadel, Seoul (KR); Chang Hyun Park, Seoul (KR); Ki Woong Jang, Seoul (KR)

(21) Appl. No.: 17/166,480

(22) Filed: Feb. 3, 2021

(30) Foreign Application Priority Data
Dec. 23, 2020 (KR) 10-2020-0182533

(51) Int. Cl. G06Q 30/06; G06Q 30/02; G06Q 20/40

(52) U.S. Cl. CPC G06Q 30/0627; G06Q 20/401; G06Q 30/0206; G06Q 30/0641

(57) ABSTRACT

According to the present disclosure, a method of providing item sales information by a computing apparatus is provided, the method including acquiring first selection information regarding an item, acquiring sub-item information applicable to the item in response to the first selection information, acquiring second selection information regarding the applicable sub-item information, and providing first amount information and second amount information in response to the second selection information, in which the first amount information is a cost corresponding to the item and is determined in response to the second selection information.

### BACKGROUND

### Technical Field

The present disclosure relates to a computing apparatus for providing item sales information and a method thereof. More specifically, the present disclosure relates to a computing apparatus, which acquires a first selection input for an item, acquires a second selection input for sub-item information applicable to the item in response to the first selection input, and provides amount information determined in response to the second selection input, and a method thereof.

### Description of the Related Art

As the use of the Internet becomes more common, the e-commerce market is expanding. In particular, with the spread of infectious diseases, interest in the field of e-commerce/online purchase where products can be purchased without face-to-face contact is rapidly increasing. For example, even when purchasing a mobile terminal, there is an increasing demand for purchasing products online in the e-commerce market.

However, when some items such as a mobile terminal are purchased online, it may be necessary not only to deliver the items to a delivery destination requested by customers through a delivery service, but also to sign up for an item-related service, determine whether to purchase additional products, or the like. For example, when a mobile terminal is purchased online, procedures for signing up for a carrier and activating an account for a terminal are required. In some cases, an additional purchase of a universal subscriber identity module (USIM), an additional subscription to insurance products, or the like may be required. However, in the past, when purchasing items such as a mobile device online, users needed to directly review items in a complex form and fill the items out online. Due to the cumbersomeness and difficulty of such a procedure, many users often avoid online purchases of items such as a mobile terminal and instead purchase the items face-to-face with a salesperson. In particular, in the case of the mobile terminal, users often visit agencies of carriers to activate accounts. In relation to this, prior art documents such as KR20130052233 or KR20100090142 may be referred to.

Accordingly, there is a desire for a method of effectively selling items such as a mobile terminal online and an apparatus using the same.

### SUMMARY

### Technical Goals

The present disclosure is directed to providing a computing apparatus and method for providing item sales information that enables a user to conveniently purchase a mobile terminal and a seller to effectively guide product sales with users and efficiently manage sales information by providing a user with sub-item information applicable to an item and acquiring a user's selection input for a sub-item.

The technical goals to be achieved by the example embodiments of the present disclosure are not limited to the technical goals described above, and other technical goals may be inferred from the following example embodiments.

### Technical Solutions

According to an aspect of the present disclosure, there is provided a method of providing item sales information by a computing apparatus, the method including: acquiring first selection information on or regarding an item; acquiring sub-item information applicable to the item in response to the first selection information; acquiring second selection information on or regarding the applicable sub-item information; and providing first amount information and second amount information in response to the second selection information, in which the first amount information is a cost corresponding to the item and is determined in response to the second selection information.

The sub-item information may be selected from one or more of sub-item sets based on attribute information corresponding to the selected item, and the attribute information may include identification information corresponding to different sub-item sets.

The second selection information may include information on or regarding one or more additional products corresponding to the item.

Delivery information corresponding to delivery information of the item may be allocated to one or more of the additional products.

One or more of the additional products may be provided from a service operator related to the use of the item, and the second amount information may be a cost paid to the service operator.

The sub-item information may be received from a first server based on the first selection information.

The first amount information and the second amount information may be received from a first server based on the second selection information.

The acquiring of the sub-item information may include receiving at least one of first sub-item information, second sub-item information, third sub-item information, and fourth sub-item information from a first server based on attribute information corresponding to the selected item, in which the first sub-item information may include information on or associated with a subscription type, the second sub-item information may include information on or associated with a rate plan, the third sub-item information may include information on or associated with a subscriber identification module corresponding to the item, and the fourth sub-item information may include information on or associated with insurance corresponding to the item.

The method may further include providing a payment page for the item according to third selection information, reacquiring the first amount information and the second amount information, and providing information on or associated with at least one of a case where the first amount information and the reacquired first amount information are different from each other, and a case where the second amount information and the reacquired second amount information are different from each other.

The method may further include providing a payment page for the item according to third selection information, and providing the first selection information and the second selection information to a second server in response to the third selection information.

The method may further include providing at least part of the first selection information and the second selection information to a third server associated with one or more of the sub-items.

The method may further include providing information related to delivery and activation of the item after checking that a user has completed payment associated with the first amount information and the second amount information.

The first selection information may include at least one of a type of the item, a storage device capacity of the item, a color of the item, and a carrier through which the item is to be activated.

According to another aspect of the present disclosure, there is provided a computing apparatus for providing item sales information including: a transceiver, a memory that stores instructions, and a processor, in which the processor is connected to the transceiver and the memory to acquire first selection information on or associated with an item, acquire sub-item information applicable to the item in response to the first selection information, acquire second selection information on or associated with the applicable sub-item information, and provide first amount information and second amount information in response to the second selection information, and the first amount information is a cost corresponding to the item and is determined in response to the second selection information.

Detailed contents of other example embodiments are described in the detailed description and are illustrated in the accompanying drawings.

### Effects

According to the present disclosure, a computing apparatus and method for providing item sales information can provide the user with the sub-item information applicable to the items when selling the items in the e-commerce market, and acquire the user's selection input for the sub-item information, thereby enabling the user to conveniently purchase the mobile terminal and the seller to effectively guide the product sales with the user and efficiently manage the sales information.

In addition, the example embodiments of the present specification can collectively provide the related information for purchase of the digital products necessary for both the sale of the items and the use of the items, and process the provided information and transfer the processed information to the related subject, thereby improving the user convenience in purchasing the items.

Effects of the present disclosure are not limited to the above-mentioned effects, and other effects that are not mentioned will be clearly understood by those skilled in the art from the description of the scope of the claims.

### BRIEF DESCRIPTION OF THE DRAWINGS

FIG. 1 is a schematic configuration diagram illustrating a system for providing item sales information according to an example embodiment.

FIG. 2 is a flowchart of an information providing method in the system for providing item sales information according to the embodiment.

FIG. 3 is a flowchart of a method of a computing apparatus receiving and providing changed information in the system for providing item sales information according to the embodiment.

FIG. 4 is a flowchart of a method of a computing apparatus receiving and providing changed information in the system for providing item sales information according to the embodiment.

FIG. 5 is a flowchart of an operation of a computing apparatus receiving third selection information in the system for providing item sales information according to the embodiment.

FIG. 6 is a flowchart of an operation of a computing apparatus checking that a user has completed payment in the system for providing item sales information according to the embodiment.

FIG. 7 is a diagram illustrating a result of displaying first amount information and second amount information provided by a computing apparatus on a user terminal according to an example embodiment.

FIG. 8 is a diagram illustrating sub-item information corresponding to first selection information according to an example embodiment.

FIG. 9 is a diagram illustrating whether partial cancellation, partial refund, and partial purchase are possible in relation to second selection information according to an example embodiment.

FIG. 10 is a diagram illustrating a method of a computing apparatus acquiring subsidy information and recommendation information according to sub-item information according to an example embodiment.

FIG. 11 is a flowchart of a method of providing item sales information of a computing apparatus according to an example embodiment.

FIG. 12 is a diagram illustrating an example of a configuration of a computing apparatus for providing item sales information according to an example embodiment.

### DETAILED DESCRIPTION

Terms that are currently widely used are selected as terms used in example embodiments in consideration of functions in the present disclosure, but may be changed depending on the intention of those skilled in the art or a judicial precedent, the emergence of a new technique, and the like. In addition, in specific cases, there may be terms arbitrarily chosen by the applicant. In this case, the meaning of such a term will be described in detail in a corresponding description portion. Therefore, the terms used in the present disclosure should be defined on the basis of the meanings of the terms and the content throughout the present disclosure rather than the simple names of the terms.

Throughout the specification, unless otherwise specified, “including” any component means that other components may be further included rather than excluding other components. In addition, the terms “-unit,” “-module,” and the like, described in the specification refer to a processing unit of at least one function or operation and may be implemented by hardware or software or a combination of hardware and software.

The expression “at least one of a, b, and c” described throughout the specification may include “a alone,” “b alone,” “c alone,” “a and b,” “a and c,” “b and c,” or “all of a, b, and c”.

A terminal described below may refer to an electronic apparatus, which may be implemented as a computer or a portable terminal capable of accessing a server or another electronic apparatus through a network. Here, computers may include, for example, a notebook, a desktop, a laptop, and the like, which are equipped with a web browser, and portable terminals are wireless communication devices that ensure portability and mobility, and may include, for example, International Mobile Telecommunications (IMT), code division multiple access (CDMA), W-code division multiple access (W-CDMA), or Long Term Evolution (LTE) terminals, and all kinds of handheld-based wireless communication devices, such as a smartphone and a tablet PC.

In the following description, example embodiments of the present disclosure will be described in detail with reference to the drawings so that those skilled in the art can easily carry out the present disclosure. The present disclosure may be embodied in many different forms and is not limited to the embodiments described herein.

Hereinafter, example embodiments of the present disclosure will be described in detail with reference to the accompanying drawings.

In describing example embodiments, descriptions of technical contents that are well known in the technical field to which the present disclosure pertains and are not directly related to the present disclosure will be omitted. This is to more clearly convey the gist of the present disclosure without ambiguity by omitting unnecessary explanations.

For the same reason, some components in the accompanying drawings are exaggerated, omitted, or schematically illustrated. In addition, the size of each component does not entirely reflect the actual size. The same reference numerals are assigned to the same or corresponding components in each drawing.

Various advantages and features of the present disclosure and methods of accomplishing them will become apparent from example embodiments to be described in detail below with reference to the accompanying drawings. However, the present disclosure is not limited to the example embodiments to be described below, but may be implemented in various different forms, these example embodiments are provided only in order to make the present disclosure complete and allow those skilled in the art to completely recognize the scope of the present disclosure, and the present disclosure is defined by the scope of the claims. Throughout the specification, like reference numerals denote like elements.

In this case, it will be appreciated that each block of a processing flowchart and combinations of the flowcharts may be executed by computer program instructions. Since these computer program instructions may be mounted in a processor of a general computer, a special computer, or other programmable data processing apparatuses, these computer program instructions executed through the process of the computer or the other programmable data processing apparatuses create means performing functions described in the block(s) of the flowchart. Since these computer program instructions may also be stored in a computer usable or computer readable memory of a computer or other programmable data processing apparatuses in order to implement the functions in a specific scheme, the computer program instructions stored in the computer usable or computer readable memory can also produce manufacturing articles including instruction means performing the functions described in the block(s) of the flowchart. Since the computer program instructions may also be mounted in the computer or the other programmable data processing apparatuses, the instructions performing a series of operation steps on the computer or the other programmable data processing apparatuses to create processes executed by the computer, thereby executing the computer or the other programmable data processing apparatuses may also provide steps for performing the functions described in the block(s) of the flowchart.

In addition, each block may indicate some of modules, segments, or codes including one or more executable instructions for executing a specific logical function(s). Further, it is to be noted that functions described in the blocks occur in a different sequence in some alternative embodiments. For example, two blocks that are shown consecutively can actually be simultaneously performed or can be performed in a reverse sequence depending on corresponding functions.

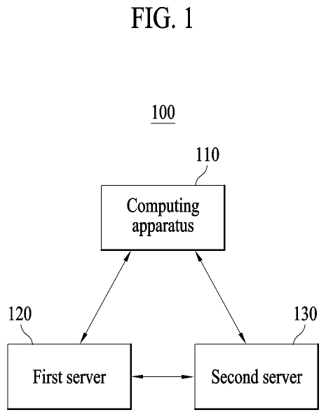

FIG. 1 is a schematic configuration diagram illustrating a system for providing item sales information according to an example embodiment.

According to various example embodiments, a system 100 for providing item sales information may include a computing apparatus 110, a first server 120, and a second server 130. According to various example embodiments, the system 100 for providing item sales information may further include a network (not shown) that supports information transmission/reception between the computing apparatus 110, the first server 120, and the second server 130.

Each of the computing apparatus 110, the first server 120, and the second server 130 may include a transceiver, a memory, and a processor. In addition, each of the computing apparatus 110, the first server 120, and the second server 130 is a unit that processes at least one function or operation, which may be implemented as hardware, software, or a combination of hardware and software. Meanwhile, in the overall embodiment, the computing apparatus 110, the first server 120, and the second server 130 are separate servers, which may have a logically divided structure, and may be implemented by a function separated from one server.

According to an example embodiment, the computing apparatus 110, the first server 120, and the second server 130 may include a plurality of computer systems implemented as a network server or computer software and may organize various types of information into a web page and provide the information. For example, at least one of the computing apparatus 110, the first server 120, and the second server 130 may be the computer system and the computer software that are connected to a lower level device capable of communicating with other network servers through a computer network such as an intranet or the Internet to accept a job execution request, perform an operation thereon, and provide an execution result. In addition, at least one of the computing apparatus 110, the first server 120, and the second server 130 may be understood broadly to include a series of application programs that may operate on a network server and various databases built therein. For example, at least one of the computing apparatus 110, the first server 120, and the second server 130 may be implemented using network server programs that are variously provided according to operating systems such as DOS, Windows, Linux, UNIX, or macOS.

The computing apparatus 110 may be an apparatus that serves to provide item sales information to a user. The computing apparatus 110 acquires first selection information on or associated with an item to provide information, acquires sub-item information applicable to the item in response to the first selection information, acquires second selection information on or associated with the applicable sub-item information, and provides first amount information and second amount information in response to the second selection information.

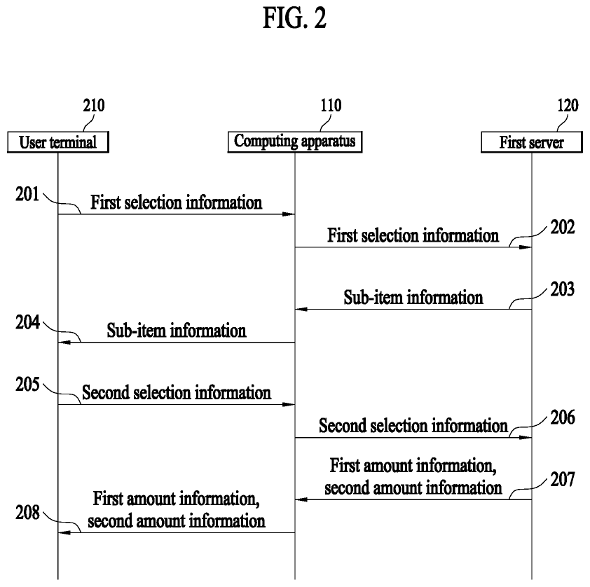

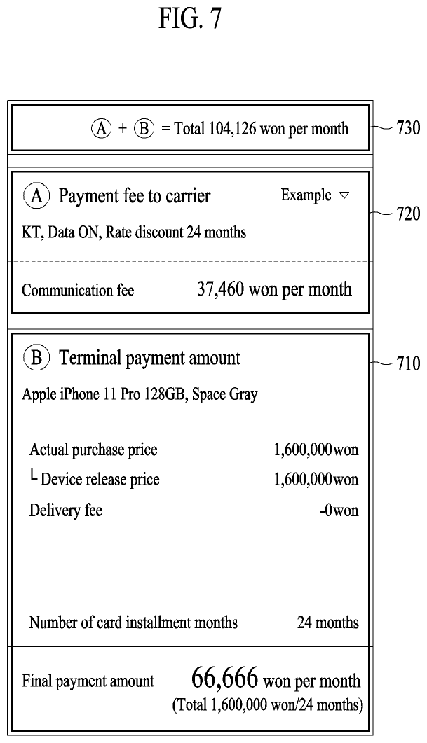

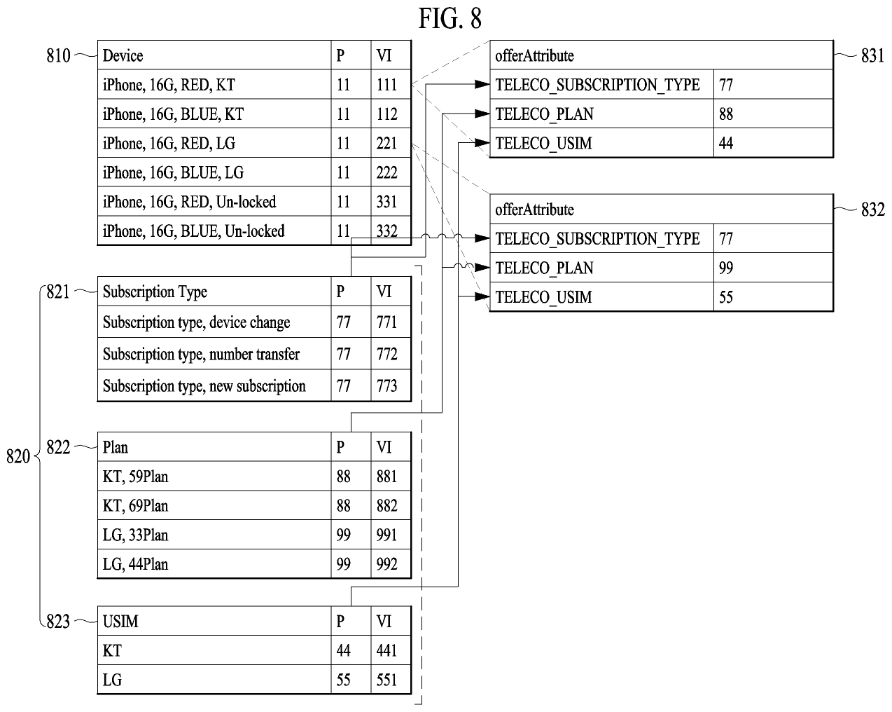

The first selection information and the second selection information will be described below in more detail with reference to FIGS. 2 and 8. The first amount information and the second amount information will be described below in more detail with reference to FIGS. 2 and 7.

In order to provide item sales information to a user, the computing apparatus 110 may transmit the first selection information of the user related to an item to the first server 120, acquire sub-item information applicable to the item from a first server 120 in response to the first selection information, transmit the second selection information of the user related to the sub-item information to the first server 120, and acquire the first amount information and the second amount information from the first server 120 in response to the second selection information. The first server 120 may generate the first amount information and the second amount information based on the second selection information. The first selection information and second selection information of the user are information received from the user and may be, for example, information transmitted from a user terminal.

According to an example embodiment, the computing apparatus 110 itself may generate at least one of the first amount information and the second amount information based on the second selection information of the user instead of transmitting the second selection information of the user to the first server 120. In this case, an item and amount information corresponding to a sub-item set may be stored in the computing apparatus 110. According to another embodiment, the computing apparatus 110 may transmit the second selection information of the user to the first server 120 and receive individual information on at least one additional product included in the second selection information from the first server 120. The computing apparatus 110 may also perform an operation of generating at least one of the first amount information and the second amount information based on the individual amount information.

Hereinafter, for convenience of description, the description is limited to the embodiment in which the second selection information of the user is transmitted to the first server 120, the first amount information and the second amount information are generated from the first server 120, and the computing apparatus 110 receives the generated first amount information and second amount information from the first server 120. However, this is only for convenience of description, and the contents of the disclosure are not limited to the case where the first amount information and the second amount information are generated by the first server 120 by the following description, and as described above, the computing apparatus 110 can generate at least part of the first amount information and the second amount information.

The computing apparatus 110 may receive third selection information and provide a payment page for an item according to the third selection information. The third selection information may be information that includes a payment request for an item and at least one additional product corresponding to the item.

According to an example embodiment, when the computing apparatus 110 receives the third selection information, the computing apparatus 110 may retransmit the first selection information and the second selection information corresponding to the third selection information to the first server 120, reacquire the first amount information and the second amount information transmitted from the first server 120, and provide information on or regarding at least one of a first case where the previously acquired first amount information and the reacquired first amount information are different from each other, and a second case where the previously acquired second amount information and the reacquired second amount information are different from each other to a user or the like.

According to an example embodiment, when the computing apparatus 110 receives the third selection information, the computing apparatus 110 may transmit the first selection information and the second selection information corresponding to the third selection information to the second server 130. In this case, the second server 130 may transmit the first selection information and the second selection information to the first server 120, acquire the first amount information and the second amount information transmitted from the first server 120, and transmit the acquired first amount information and second amount information to the computing apparatus 110. The computing apparatus 110 may provide the information on at least one of the first case where the first amount information previously acquired from the first server 120 and the first amount information acquired from the second server 130 are different from each other and the second case where the second amount information previously acquired from the first server 120 and the second amount information acquired from the second server 130 is different from each other to the user or the like.

As a result, it is possible to verify whether there are changes in the first amount information and the second amount information by the computing apparatus 110.

A network may be used for communication between the computing apparatus 110, the first server 120, and the second server 130. In addition, the network may be used for communication between the user terminal and the computing apparatus 110.

The computing apparatus 110 according to the embodiment may transmit information corresponding to completion of payment to the second server 130 upon receiving payment completion information confirming the user's payment. The information corresponding to the completion of payment may be information indicating that the user has completed the payment, and may be information including first selection information and second selection information of the user.

The first server 120 may be a server that stores the sub-item set information and stores the item and the amount information corresponding to the sub-item set. In addition, the first server 120 may include information on or regarding which sub-item is applicable to each item of a plurality of sub-items included in the sub-item set. According to an example embodiment, the first server 120 may store an item together with the item information by associating the item with the list of applicable sub-items.

The first server 120 may correspond to a server that generates sub-item information applicable to an item in response to the selection information of the user and generates the first amount information and the second amount information related to the item. Specifically, the first server 120 may receive the first selection information of the user related to the item from the computing apparatus 110, generate the sub-item information applicable to the item in response to the first selection information, and transmit the generated sub-item information to the computing apparatus 110. In addition, the first server 120 may receive the second selection information for the applicable sub-item information from the computing apparatus 110, generate the first amount information and the second amount information related to the item in response to the second selection information, and transmit the generated first amount information and second amount information to the computing apparatus 110. According to an example embodiment, the first server 120 may receive the first selection information and the second selection information from the second server 130 and generate the first amount information and the second amount information related to the item in response to the second selection information received from the second server 130. In this case, the first server 120 may transmit the generated first amount information and second amount information to at least one of the computing apparatus 110 and the second server 130.

The second server 130 may correspond to a server responsible for transmitting/receiving and processing information related to payment of an item. Upon receiving the first selection information and the second selection information from the computing apparatus 110, the second server 130 may determine that the computing apparatus 110 has received the third selection information that includes a payment request for an item and at least one additional product corresponding to the item. The second server 130 that receives the first selection information and the second selection information from the computing apparatus 110 may transmit the first selection information and the second selection information to the first server 120, acquire the first amount information and the second amount information transmitted from the first server 120, and transmit the acquired first amount information and second amount information to the computing apparatus 110. As a result, it is possible to verify whether there are changes in the first amount information and the second amount information in the computing apparatus 110.

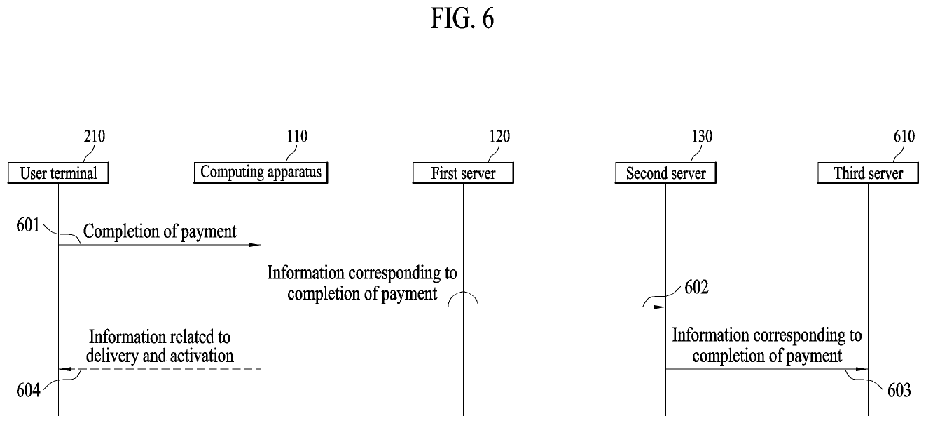

According to an example embodiment, the second server 130 may receive information corresponding to the user's payment completion information from the computing apparatus 110. In this case, the second server 130 may provide the information corresponding to the completion of payment to a third server (e.g., a third server 610 of FIG. 6) associated with at least one of the sub-items. As described above, the information corresponding to the completion of payment may be information indicating that the user has completed the payment and may be information including the first selection information and second selection information of the user.

The method of providing item sales information by the computing apparatus 110, the first server 120, and the second server 130 in the system 100 for providing item sales information will be described below in more detail with reference to FIGS. 2 to 6.

Operations related to the method of providing a series of item sales information according to various example embodiments may be implemented by a single physical device or may be implemented in a manner in which a plurality of physical devices are organically combined. For example, some of the components included in the system 100 for providing item sales information may be implemented by any one physical device, and the remaining components may be implemented by another physical device. For example, any one physical device may be implemented as a part of the computing apparatus 110, and another physical device may be implemented as a part of the first server 120 or a part of the second server 130 or as a part of an external device. In some cases, the components included in the system for providing item sales information are each distributed and arranged in different physical devices, and the distributed components may be organically combined to perform the functions and operations of the system 100 for providing item sales information. For example, the computing apparatus 110 of the present specification may include at least one sub-device, and some operations described as being performed by the computing apparatus 110 may be performed by a first sub-device, and other operations may be performed by a second sub-device.

FIG. 2 is a flowchart of an information providing method in the system for providing item sales information according to the example embodiment. Hereinafter, in FIGS. 2 to 6, for convenience of description, the description is limited to a case where the computing apparatus 110 receives user information through the user terminal 210. The user terminal 210 may correspond to the user terminal described in FIG. 1.

Referring to FIG. 2, in operation 201, the computing apparatus 110 may acquire the first selection information on the item from the user terminal 210. The user may generate the first selection information by selecting an item desired to be purchased from among item candidates displayed on the user terminal 210. The item candidates displayed on the user terminal 210 may be previously displayed by the computing apparatus 110, but are not necessarily limited thereto, and may be previously displayed by other devices. Meanwhile, in an example embodiment, the first selection information may be input through at least one of a product information page and a list page in the user terminal.

The first selection information may be user selection information related to detailed features of the item. According to an example embodiment, when the item is a communicable electronic device (for example, a portable terminal), the first selection information may include at least one of a model of the item, a storage device capacity of the item, a color of the item, and a carrier through which the item is to be activated. For example, the first selection information may include information such as “Apple iPhone 11 Pro 128 GB, Space Gray, XX carrier.”

Hereinafter, for convenience of description, the description is limited to the case where the item is the portable terminal. However, the item of the present disclosure is not limited to the portable terminal, and the contents of the present disclosure may be broadly applied to items for which a determination of the subscription of related services, the purchase of additional products, or the like is further made at the time of the purchase.

The computing apparatus 110 may transmit the acquired first selection information to the first server 120 in operation 202 and obtain the sub-item information applicable to the item from the first server 120 in response to the transmitted first selection information in operation 203. The sub-item information acquired in response to the first selection information may be selected from at least one of the sub-items based on attribute information corresponding to the item selected by the user, and the attribute information may include identification information corresponding to different sub-item sets.

According to an example embodiment, the sub-item information may include at least part of first sub-item information including information on or corresponding to a subscription type of an item, second sub-item information including information on or corresponding to a rate plan, third sub-item information including information on or corresponding to a subscriber identification module (for example, universal subscriber identity module (USIM)) corresponding to an item, and fourth sub-item information including information on or corresponding to insurance corresponding to an item. For example, when the item is “iPhone, 16G, RED, KT,” the first sub-item information may include “device change,” “number transfer,” and “new subscription,” the second sub-item information may include “KT, 59Plan” and “KT, 69Plan,” the third sub-item information may include “whether to purchase KT USIM,” and the fourth sub-item information may include “whether to sign up for AppleCare.”

The computing apparatus 110 may transmit the acquired sub-item information to the user terminal 210 in operation 204 and acquire the second selection information on the sub-item information in operation 205. The second selection information is information selected by a user among the sub-item information and may include information on at least one additional product corresponding to an item. At least one of the additional products may be allocated delivery information corresponding to the delivery information of the item. In this case, at least one of the additional products may be delivered through a courier. Alternatively, at least one of the additional products may be provided from a service operator related to the use of the item.

The additional products delivered through the courier and the additional products provided from the service operator do not necessarily have to be separate, and it is also possible for the additional products provided from some service operators to be delivered through the courier. For example, when the item is a portable terminal and the additional product includes a specific kind of USIM provided by the service operator (for example, a communication operator), a user will receive the USIM through a courier. In addition, in an example embodiment, the USIM may be allocated delivery information corresponding to the portable terminal, and the portable terminal and the USIM may be delivered together.

The computing apparatus 110 may transmit the acquired second selection information to the first server 120 in operation 206 and may receive first amount information and the second amount information from the first server 120 in operation 207. The first amount information may be amount information determined in response to not only the first selection information but also the second selection information as a cost (price of a portable terminal) corresponding to the item. In other words, the cost corresponding to the item may vary according to sub-item selection information. For example, an amount corresponding to the first amount information may be lower than a general selling price of an item because a user using a high rate plan receives a subsidy from a service operator.

When at least some of the additional products are provided from a service operator related to the use of the item, the second amount information may include a cost paid to the service operator. For example, when the additional product includes a specific communication rate plan provided by a service operator, the second amount information may include amount information corresponding to the specific communication rate plan.

When delivery information corresponding to the delivery information of the item is allocated to at least some of the additional products (for example, when delivered through a courier), the second amount information may include the price of the additional product, and in some cases, may include the delivery cost. For example, when the additional product includes a protective case of a portable terminal, the second amount information may include price information of the protective case.

A method of displaying the first amount information and the second amount information may vary according to a payment method of a user. Specifically, when the user selects lump sum payment, the first amount information and the second amount information may simply display a cost corresponding to an item and a cost corresponding to an additional product. On the other hand, when a user selects installment payment, the first amount information and the second amount information may be displayed by dividing the cost corresponding to the item and the cost corresponding to the additional product according to the number of installment months, and when there is an interest rate related to the installment, information calculated in consideration of the interest rate may be displayed.

The payment methods for the first amount information and the second amount information do not have to be identical. In addition, even within the second amount information, the payment methods for all additional products do not have to be identical. For example, the user may pay the rate plan in installments, but may pay the cost corresponding to the item and the cost of the USIM in a lump sum. In this case, the first amount information and the second amount information may be displayed in a manner that cost paid in installments and cost paid in a lump sum can be differentiated.

The computing apparatus 110 may transmit the received first amount information and second amount information to the user terminal 210 in operation 208. The first amount information and the second amount information may be output to the user terminal 210.

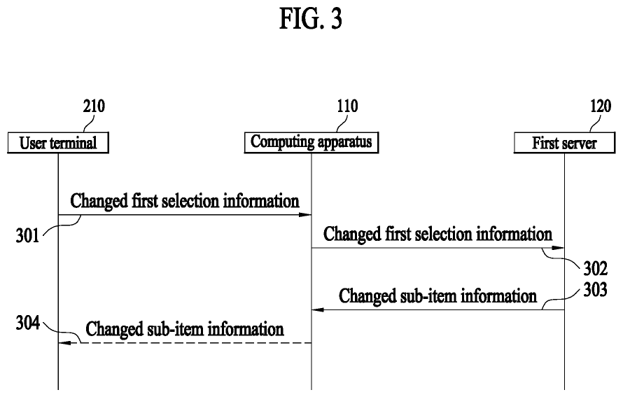

According to an example embodiment, when the changed first selection information or the changed second selection information is transmitted from the user terminal 210, the computing apparatus 110 may acquire the changed sub-item information or the changed amount information. In addition, the computing apparatus 110 may transmit the changed sub-item information or the changed amount information to the user terminal 210, and item information or price information checked by a user may be changed and displayed in real time according to the user's selection. Specifically, referring to FIG. 3, when the changed first selection information is received from the user terminal 210 in operation 301, the computing apparatus 110 may transmit the changed first selection information to the first server 120 in operation 302 and receive the changed sub-item information from the first server 120 in operation 303. According to an example embodiment, the computing apparatus 110 may transmit the changed sub-item information to the user terminal 210 in operation 304.

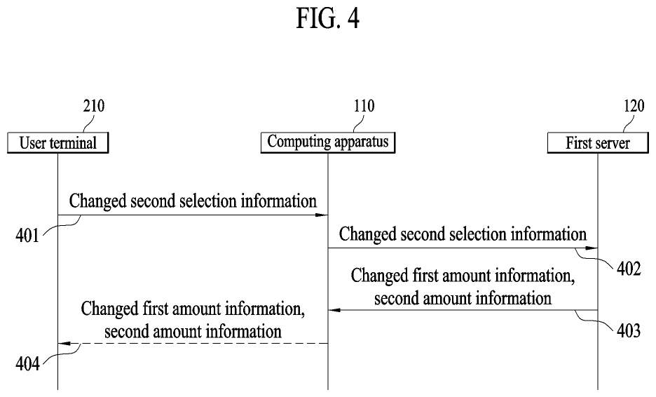

In addition, referring to FIG. 4, when the changed second selection information is received from the user terminal 210 in operation 401, the computing apparatus 110 may transmit the changed second selection information to the first server 120 in operation 402 and receive the changed sub-item information and second amount information from the first server 120 in operation 403. According to an example embodiment, the computing apparatus 110 may transmit the changed first amount information and second amount information to the user terminal 210 in operation 404.

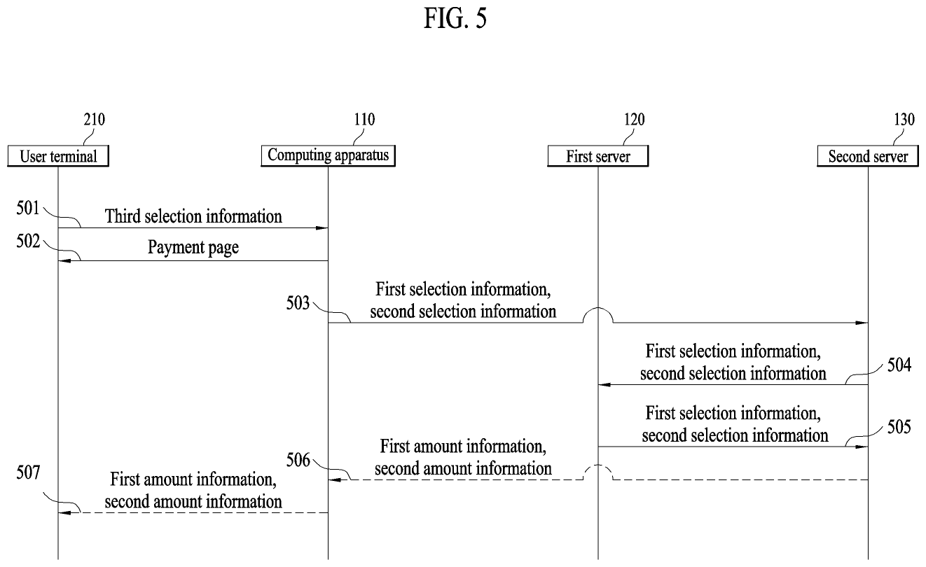

FIG. 5 is a flowchart of the computing apparatus receiving the third selection information in the system for providing item sales information according to the example embodiment.

Referring to FIG. 5, in operation 501, the computing apparatus 110 according to the embodiment may receive, from the user terminal 210, the third selection information that includes an item and a payment request for at least one additional product corresponding to the item. In operation 502, the computing apparatus 110 may provide a payment page for an item to the user terminal 210 according to the third selection information. The payment page may display first selection information and second selection information selected by the user and may display the first amount information and the second amount information. In an example embodiment, a product information page, a list page, and a payment page are described as being collectively provided by the computing apparatus 110, but are not limited thereto, and at least some of the three pages may be provided by each computing apparatus.

In the drawings, it is shown that the computing apparatus 110 may provide the payment page for the item to the user terminal 210 immediately after receiving the third selection information, but according to the embodiment, it may provide the payment page after operations 503 to 505 to be described below are completed. In this case, the payment page may be provided with the first amount information and the second amount information for which the change is verified in operations 503 to 505 to be described below.

Alternatively, according to an example embodiment, after the computing apparatus 110 receives the third selection information, the payment page for the item may be immediately provided to the user terminal 210, and after operations 503 to 505 to be described below are completed, the first amount information and the second amount information for which the change is verified may be provided to the user terminal 210 again. In this case, the user terminal 210 may update the first amount information and the second amount information.

In operation 503, the computing apparatus 110 receiving the third selection information may transmit the first selection information and the second selection information corresponding to the third selection information to the second server 130. In operation 505, the second server 130 may transmit the first selection information and the second selection information to the first server 120 and may receive the first amount information and the second amount information corresponding to the transmitted first selection information and second selection information.

In operation 506, the second server 130 may transmit the first amount information and the second amount information received from the first server 120 to the computing apparatus 110. According to an example embodiment, the second server 130 may simply transmit the received first amount information and second amount information to the computing apparatus 110 without performing additional determination. According to another embodiment, the second server 130 may determine whether the received first amount information and second amount information are different from the first amount information and the second amount information previously generated by the computing apparatus 110, and may transmit the received first amount information and second amount information to the computing apparatus 110 only when it is determined that the received first amount information and second amount information are different from the first amount information and the second amount information. In this case, in operation 503, the computing apparatus 110 may transmit not only the first selection information and the second selection information, but also the generated first amount information and second amount information to the second server 130.

In operation 507, the computing apparatus 110 may display the first amount information and second amount information received from the second server on the user terminal 210. When the second server 130 simply transmits the first amount information and the second amount information received from the first server 120 to the computing apparatus 110 without performing additional determination, the computing apparatus 110 may determine whether the first amount information and the second amount information received from the second server 130 are different from the previously generated first amount information and second amount information, and transmit the first amount information and second amount information received from the second server 130 to the user terminal 210 only when it is determined that the first amount information and the second amount information received from the second server 130 are different from the previously generated first amount information and second amount information.

As described above, according to an example embodiment, a payment page may be provided after operations 503 to 505 are completed. Specifically, when the first amount information and the second amount information are received from the second server 130 in operation 506, the computing apparatus 110 may provide the payment page, which includes the first amount information and the second amount information received from the second server 130, to the user terminal 210. When the first amount information and the second amount information are not received from the second server 130, the computing apparatus 110 may provide the payment page, which includes the previously generated first amount information and second amount information, to the user terminal 210. In this case, the second server 130 may transmit a message indicating that there is no change in the first amount information and the second amount information in the computing apparatus 110 so that the computing apparatus 110 may recognize that there is no change in the first amount information and the second amount information. Alternatively, after the computing apparatus 110 transmits the first selection information and the second selection information to the second server 130 in operation 503, the computing apparatus 110 may consider that there is no change in the first amount information and the second amount information when there is no response from the second server 130 for a period of time exceeding a predetermined threshold time (for example, 10 ms).

When the payment page is provided after operations 503 to 505 are completed, the first amount information and the second amount information for which the change is verified may be provided to the user terminal 210 through the payment page.

FIG. 6 is a flowchart of the computing apparatus checking that a user has completed payment in the system for providing item sales information according to the example embodiment.

Referring to FIG. 6, in operation 601, the user terminal 210 may transmit payment completion information confirming the user's payment to the computing apparatus 110. In operation 602, the computing apparatus 110 may transmit information corresponding to completion of payment to the second server 130. As described above, the information corresponding to the completion of payment may be information indicating that the user has completed the payment, and may be information including the first selection information and the second selection information of the user. In operation 603, the second server 130 may provide the information corresponding to the completion of payment to a third server associated with at least some of the sub-items. The third server 610 may be a server corresponding to the third server of FIG. 1.

The third server 610 may be a server operated by a service operator. As an example, when an item corresponds to a portable terminal, the third server 610 may correspond to a carrier server operated by a carrier as a service operator.

According to an example embodiment, the computing apparatus 110 may directly transmit information corresponding to the completion of payment to the third server 610 without going through the second server 130.

According to an example embodiment, the computing apparatus 110 may transmit the first selection information and the second selection information to the third server 610 even when payment is not confirmed.

According to an example embodiment, in operation 604, the computing apparatus 110 may transmit information related to delivery and activation to the user terminal 210. The information related to the delivery and activation may include time information indicating when delivery may take place and time information indicating when activation may be performed. It may be determined when delivery is made in consideration of a state of a distribution center, a courier's working state, a service operator's state, and the like. It may be determined when the activation may take place in consideration of the state of the service operator or the like.

The computing apparatus 110 may generate information related to delivery and activation based on the received payment completion information and transmit the generated information to the user terminal 210. Alternatively, the computing apparatus 110 may receive information related to delivery and activation from the second server 130 and transmit the received information to the user terminal 210. Alternatively, at least part of the information related to the delivery and activation may be generated by the computing apparatus 110 and the remaining part may be generated by the second server 130.

FIG. 7 is a diagram illustrating a result of displaying the first amount information and the second amount information provided by the computing apparatus on the user terminal according to the example embodiment.

Referring to FIG. 7, the first amount information provided by the computing apparatus 110 according to the embodiment may correspond to a terminal payment amount as indicated by reference numeral 710, and the second amount information may correspond to a payment fee to a carrier as indicated by reference numeral 720. Since the first amount information may be determined in response to not only the first selection information but also the second selection information, the user terminal 210 may further display at least part of the first selection information and the second selection information in consideration of the determined first amount information when displaying the first amount information. For example, in displaying the first amount information, information such as “Apple iPhone 11 Pro 128 GB, Space Gray” may be displayed as the first selection information.

According to an example embodiment, the first amount information may include amount information subdivided into device release price information, actual amount information, delivery fee information, and the like. For example, the first amount information may include amount information subdivided into “actual purchase price, 1,600,000 won,” “device release price, 1,600,000 won,” “delivery fee, 0 won,” and the like.

According to an example embodiment, when the user selects installment payment in relation to the first amount information, the first amount information may include the number of installment months, and include amount information calculated according to the number of installment months. For example, the first amount information may include information such as “number of card installment months, 24 months” and “final payment amount, 66,666 won.” In addition, when the user selects installment payment, the first amount information may include a process of calculating amount information based on the number of installment months. For example, the first amount information may include information such as “total 1,600,000 won/24 months.”

According to an example embodiment, since the second amount information may be determined in response to not only the first selection information but also the second selection information, the user terminal 210 may further display at least part of the first selection information and the second selection information in consideration of the determined second amount information when displaying the second amount information. For example, in displaying the second amount information, information such as “KT, data ON” may be displayed as the second selection information.

According to an example embodiment, when the user selects installment payment in relation to the second amount information, the second amount information may include the number of installment months and include amount information calculated according to the number of installment months. For example, the second amount information may include information such as “rate discount, 24 months” and “communication fee, 37,460 won per month.”

According to an example embodiment, as indicated by reference numeral 730, the sum of the first amount information and the second amount information may be further displayed on the user terminal 210. The sum of the first amount information and the second amount information may correspond to an amount that the user should substantially bear.

Although not illustrated in the drawings, the first amount information may be determined in correspondence with the second selection information as well as the first selection information. For example, when the second selection information includes an expensive rate plan, a subsidy is provided from a carrier for the terminal payment amount which is the first amount information, and thus the first amount information may be further lowered.

FIG. 8 is a diagram illustrating the sub-item information corresponding to the first selection information according to the example embodiment.

Referring to FIG. 8, the computing apparatus 110 may acquire sub-item information applicable to an item in response to the first selection information. Reference numeral 810 may correspond to a list of items that a user may select. Reference numeral 820 may include the sub-item information applicable to the item. As illustrated in reference numerals 810 and 820, the list of items that the user may select, the identification number (VI in the drawing) and attribute information (P in the drawing) of the sub-item information applicable to the item may be assigned as a number.

Reference numeral 810 may correspond to the list of items that the user may select. As illustrated in reference numeral 810, the list of items that the user may select may be subdivided according to the model of the item, the storage device capacity of the item, the color of the item, the carrier through which the item is to be activated, and the like. In addition, the list of items that the user may select may include an option not to activate an item through a specific carrier so that the user may purchase an empty machine without subscribing to a specific carrier's contract. For example, if the model of the item corresponds to “iPhone,” the list of items that the user may select may include “iPhone, 16G, RED, KT,” “iPhone, 16G, BLUE, KT,” “iPhone, 16G, RED, LG,” “iPhone, 16G, BLUE, LG,” “iPhone, 16G, RED, Un-locked,” “iPhone, 16G, BLUE, Un-locked,” and the like, and Un-locked may correspond to the case where a user purchases a terminal without subscribing to the specific carrier's contract.

The sub-item information applicable to the item may be determined in response to the first selection information of the user. For example, when the user selects “iPhone, 16G, RED, KT” corresponding to reference numeral 831, SUBSCRIPTION_TYPE may be determined as 77, PLAN may be determined as 88, and USIM may be determined as 44, which may mean that the sub-item information with the attribute information of 77 in relation to the subscription type is applicable, the sub-item information with the attribute information of 88 in relation to the rate plan is applicable, and the sub-item information with the attribute information of 44 in relation to whether to purchase the USIM is applicable. Alternatively, when the user selects “iPhone, 16G, RED, KT” corresponding to reference numeral 832, SUBSCRIPTION_TYPE may be determined as 77, PLAN may be determined as 99, and USIM may be determined as 55, which may mean that the sub-item information with the attribute information of 77 in relation to the subscription type is applicable, the sub-item information with the attribute information of 99 in relation to the rate plan is applicable, and the sub-item information with the attribute information of 55 in relation to whether to purchase the USIM is applicable.

Reference numeral 820 may include the sub-item information applicable to the item. As illustrated in reference numeral 820, the sub-item information that the user may select may be provided by being subdivided into a subscription type 821, a rate plan 822, whether to purchase a USIM 823, and the like. In addition, the sub-item information is assigned the attribute information (P in the drawing) and the identification information (VI in the drawing) of the sub-item for the detailed options, and it may be determined which detailed option is selected based on the first selection information of the user. For example, when a user selects “iPhone, 16G, RED, KT” corresponding to reference numeral 831, since SUBSCRIPTION_TYPE is determined as 77, PLAN is determined as 88, and USIM is determined as 44, the sub-item information provided to the user may include “subscription type, device change,” “subscription type, number transfer,” and “subscription type, new subscription” with attribute information of 77 in relation to a subscription type 821, include “KT, 59Plan” and “KT, 69Plan” with attribute information of 88 in relation to a rate plan 822, and “KT” with attribute information of 44 in relation to whether to purchase a USIM 823. Alternatively, when a user selects “iPhone, 16G, RED, KT” corresponding to reference numeral 832, since SUBSCRIPTION_TYPE is determined as 77, PLAN is determined as 99, and USIM is determined as 55, the sub-item information provided to the user may include “subscription type, device change,” “subscription type, number transfer,” and “subscription type, new subscription” with attribute information of 77 in relation to a subscription type 821, include “LG, 33Plan” and “LG, 44Plan” with attribute information of 99 in relation to a rate plan 822, and “LG” with attribute information of 55 in relation to whether to purchase a USIM 823.

The computing apparatus 110 may store an item together with the item information by associating the item with the list of applicable sub-item information.

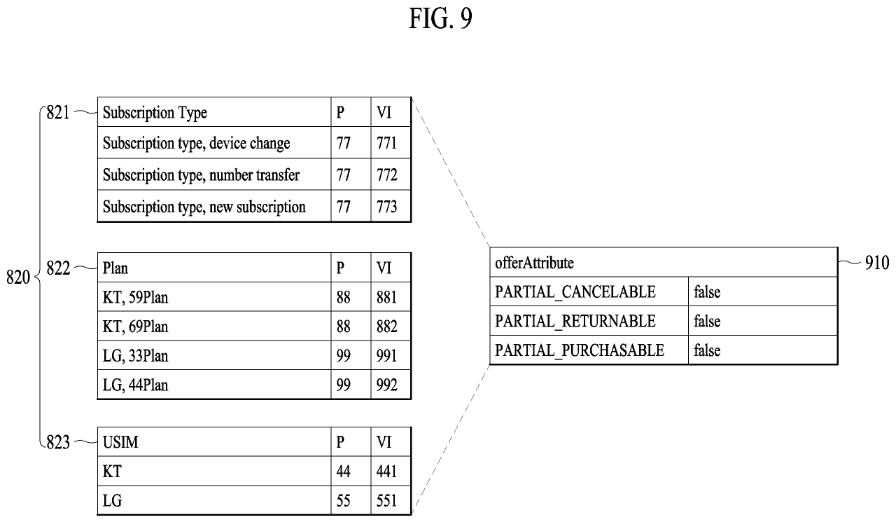

FIG. 9 is a diagram illustrating an example of whether partial cancellation, partial refund, and partial purchase are possible in relation to the second selection information according to the example embodiment.

Referring to FIG. 9, prior to providing the item sales information to the user, when the sub-items applicable to an item are purchased together, it may be determined in advance whether the partial cancellation, the partial refund, and the partial purchase are possible. For some sub-items such as the subscription type or the rate plan, it may be inappropriate to purchase a sub-item without purchasing an item, or to cancel the purchase or request a refund for only the item after purchasing the item and the sub-item together. Accordingly, the computing apparatus 110 may previously set, as a separate value, whether the partial purchase cancellation, the partial refund, and the partial purchase are possible for at least some of the sub-items according to the determination of a seller or a service operator (for example, a carrier). For example, for at least some of the sub-items, the computing apparatus 110 may set a “PARTIAL_CANCELABLE” value to false to set the partial purchase cancellation to be impossible, set a “PARTIAL_RETURNABLE” value to false to set the partial refund to be impossible, and set a “PARTIAL_PURCHASABLE” value to false to set the partial purchase to be impossible as indicated by reference numeral 910.

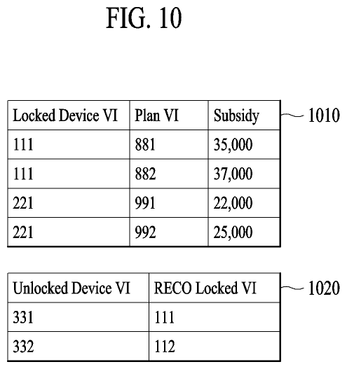

FIG. 10 is a diagram illustrating a method of a computing apparatus acquiring subsidy information and recommendation information according to sub-item information according to an example embodiment.

Referring to FIG. 10, the first amount information may be determined in correspondence with the second selection information as well as the first selection information. For example, when the second selection information includes an expensive rate plan, a subsidy is provided from a carrier for the terminal payment amount which is the first amount information, and thus the first amount information may be further lowered.

The computing apparatus 110 may further store the subsidy information together with the sub-item information as indicated by reference numeral 1010. The subsidy information may vary according to an item and sub-item that a user may select, and may be stored in association with identification information (VI in FIG. 8) related to the item and sub-item. An example of storing information indicating that, when the identification information of the item is 111 and the identification information of the rate plan is 881, a subsidy is 35,000 won, when the identification information of the item is 111 and the identification information of the rate plan is 882, a subsidy is 37,000 won, when the identification information of the item is 221 and the identification information of the rate plan is 991, a subsidy is 22,000 won, and when the identification information of the item is 221 and the identification information of the rate plan is 992, a subsidy is 25,000 won is illustrated in 1010. Referring further to the identification information illustrated in FIG. 8, it can be seen that information indicating that, when a user selects an item of “iPhone, 16G, RED, KT,” when a rate plan is “KT, 59Plan,” a subsidy of 35,000 won is provided, and when a rate plan is “KT, 69Plan,” a subsidy of 37,000 won is provided, when a rate plan is “LG, 33Plan,” a subsidy of 22,000 won is provided, and when a rate plan is “LG, 44Plan,” a subsidy of 25,000 won is provided corresponds to reference numeral 1010.

When a user selects an empty machine as an item without subscribing to a specific carrier's contract, the computing apparatus 110 may recommend that the user subscribe to a specific carrier, and the recommendation information may be stored in the computing apparatus 110 in association with the identification information of the item. An example of storing information indicating that, when the identification information of the item is 331, the item of the identification information 111 is recommended, and when the identification information of the item is 332, the item of the identification information 112 is recommended is illustrated in reference numeral 1020. Referring further to the identification information illustrated in FIG. 8, it can be seen that information indicating that, when a user selects an item of “iPhone, 16G, RED, Un-locked,” an item of “iPhone, 16G, RED, KT” is recommended, and when a user selects “iPhone, 16G, BLUE, Un-locked,” an item of “iPhone, 16G, BLUE, KT” is recommended corresponds to reference numeral 1020.

According to an example embodiment, the first server 120 may store an item together with the item information by associating the item with the list of applicable sub-items.

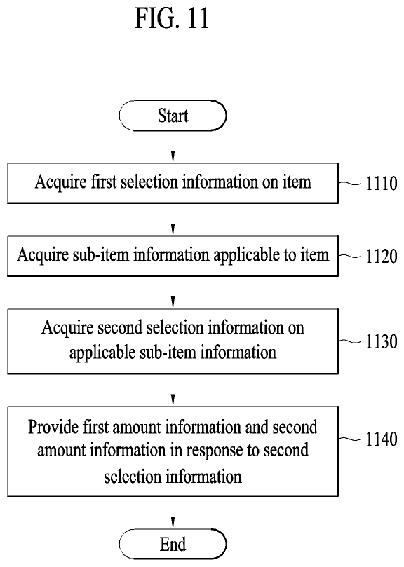

FIG. 11 is a flowchart of an information providing method of a computing apparatus according to an example embodiment.

Referring to FIG. 11, the computing apparatus 110 according to the embodiment acquires first selection information for an item in operation 1110 and acquires sub-item information applicable to the item in response to the first selection information in operation 1120. The sub-item information may be selected from at least one of the sub-item sets based on attribute information corresponding to the selected item, and the attribute information may include identification information corresponding to different sub-item sets.

The computing apparatus 110 acquires second selection information for applicable sub-item information in operation 1130 and provides first amount information and second amount information in response to the second selection information in operation 1140. The second selection information may include information on at least one additional product corresponding to the item. The first amount information and the second amount information may be received from the first server based on the second selection information.

The first amount information is a cost corresponding to the item and is amount information determined in response to the second selection information. The second amount information may be a cost paid to a service operator related to the use of the item.

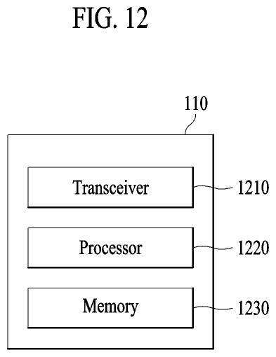

FIG. 12 is a diagram illustrating an example of a configuration of a computing apparatus for providing item sales information according to an example embodiment.

Referring to FIG. 12, the computing apparatus 110 includes a transceiver 1210, a processor 1220, and a memory 1230. The computing apparatus 110 is connected to the user terminal 210, the first server 120, the second server 130, an external device (for example, the third server 610), and the like through the transceiver 1210, and may exchange data therebetween.

The processor 1220 may include at least one of the devices described above with reference to FIGS. 1 to 11 or may perform at least one method described above with reference to FIGS. 1 to 11. The memory 1230 may store information (including first selection information, second selection information, first amount information, and second amount information) for performing at least one method described above with reference to FIGS. 1 to 11. The memory 1230 may be a volatile memory or a nonvolatile memory.

The processor 1220 may control the computing apparatus 110 for executing a program and providing information. A code of the program executed by the processor 1220 may be stored in the memory 1230.

In addition, the computing apparatus 110 according to the embodiment may further include an interface capable of providing information to a user.

The present specification and drawings have been described with respect to the example embodiments of the present disclosure. Although specific terms are used, it is only used in a general sense to easily explain the technical content of the present disclosure and to help the understanding of the invention, and is not intended to limit the scope of the specification. It will be apparent to those skilled in the art that other modifications based on the technical spirit of the present disclosure may be implemented in addition to the embodiments disclosed herein.

The electronic apparatus or terminal according to the above-described embodiments may include a processor, a memory that stores and executes program data, a permanent storage such as a disk drive, a communication port that communicates with an external device, a touch panel, a key, a user interface device such as a button, and the like. Methods implemented as software modules or algorithms may be stored on a computer-readable recording medium as computer-readable codes or program instructions executable on the processor. Here, examples of the computer-readable recording medium may include magnetic storage media (for example, a read-only memory (ROM), a random-access memory (RAM), a floppy disk, a hard disk, etc.), optical reading media (for example, a compact disc (CD)-ROM or a digital versatile disc (DVD)), and the like. The computer-readable recording medium may be distributed in computer systems connected to each other through a network, and as a result, the computer-readable codes may be stored in a distributed scheme and executed. The medium may be readable by a computer, stored in a memory, and executed on a processor.

The present embodiments may be represented by functional block configurations and various processing steps. These functional blocks may be implemented by various numbers of hardware and/or software components that execute specific functions. For example, the embodiment may employ integrated circuit configurations, such as a memory, processing, logic, and a look-up table, capable of executing various functions by control of one or more microprocessors or other control devices. Similar to executing the components in software programming or software elements, the present embodiment can be implemented in programming or scripting languages such as python, C, C++, Java, and assembler, including various algorithms implemented by a combination of data structures, processes, routines or other programming configurations. Functional aspects may be implemented in algorithms executed on one or more processors. In addition, the present embodiments may employ a conventional technology for electronic environment setting, signal processing, and/or data processing, and the like. Terms such as “mechanism,” “element,” “means,” and “configuration” may be used broadly, and are not limited to mechanical and physical configurations. The terms may include the meaning of a series of routines of software in connection with a processor or the like.

The above-described example embodiments are merely examples, and other embodiments may be implemented within the scope of the following claims.

1. A method of providing item sales information by a computing apparatus, the method comprising:
acquiring a first selection of an item from a plurality of items, wherein the item is associated with a plurality of attributes;
acquiring sub-item information associated with the item in response to the first selection, the sub-item information identifying a set of sub-items associated with the plurality of attributes of the item, wherein each item of the plurality of items is associated with a particular set of sub-items of a plurality of sets of sub-items;
causing a display of a user terminal to display the sub-item information;
acquiring a second selection of a plurality of values for the set of sub-items, wherein the second selection comprises a selection of one or more additional products by a user associated with the user terminal;
obtaining first cost information and second cost information in response to the second selection, wherein the first cost information and the second cost information are based on the plurality of values for the set of sub-items, the first cost information associated with a first payment method format and comprising a base cost of the item, the second cost information associated with a second payment method format and comprising an additional cost associated with the item, wherein the second cost information further comprises a cost associated with the one or more additional products, wherein the second payment method format is different from the first payment method format, and wherein the first cost information is based on the first selection and the second selection;
obtaining, from the user terminal, payment method information indicating a third payment method format, wherein the third payment method format is different from the first payment method format and the second payment method format; and
causing the display of the user terminal to display the first cost information and the second cost information according to the third payment method format based on the payment method information.

2. (canceled)

3. (canceled)

4. The method of claim 1, wherein delivery information corresponding to delivery information of the item is allocated to at least one of the one or more additional products.

5. The method of claim 1, wherein at least one of the one or more additional products are provided by a service operator related to a use of the item, and
wherein the second cost information comprises a cost paid to the service operator.

6. The method of claim 1, wherein the sub-item information is acquired from a server based on the first selection.

7. The method of claim 1, wherein the first cost information and the second cost information are received from a server based on the second selection.

8. The method of claim 1, wherein acquiring the sub-item information comprises receiving at least one of first sub-item information, second sub-item information, third sub-item information, or fourth sub-item information from a server based on attribute information corresponding to the item,
wherein the first sub-item information comprises information on a subscription type,
wherein the second sub-item information comprises information on a rate plan,
wherein the third sub-item information comprises information on a subscriber identification module corresponding to the item, and
wherein the fourth sub-item information comprises information on insurance corresponding to the item.

9. The method of claim 1, further comprising:
causing the display of the user terminal to display a payment page for the item according to a third selection;
reacquiring the first cost information and the second cost information; and
providing information on at least one of a first case where the first cost information and the reacquired first cost information are different from each other, and a second case where the second cost information and the reacquired second cost information are different from each other.

10. The method of claim 1, further comprising:
causing the display of the user terminal to display a payment page for the item according to a third selection; and
providing the first selection and the second selection to a server in response to the third selection.

11. The method of claim 1, further comprising:
providing at least a portion of the first selection and the second selection to a server associated with at least one of the plurality of sub-items.

12. The method of claim 1, further comprising:
providing information related to delivery and activation of the item after verifying that a user has completed payment associated with the first cost information and the second cost information.

13. The method of claim 1, wherein the first selection comprises at least one of a model of the item, a storage device capacity of the item, a color of the item, or a carrier through which the item is to be activated.

14. A non-transitory computer-readable recording medium on which a program allowing a computer to:
acquire a first selection of an item from a plurality of items, wherein the item is associated with a plurality of attributes;
acquire sub-item information associated with the item in response to the first selection, the sub-item information identifying a set of sub-items associated with the plurality of attributes of the item, wherein each item of the plurality of items is associated with a particular set of sub-items of a plurality of sets of sub-items;
cause a display of a user terminal to display the sub-item information;
acquire a second selection of a plurality of values for the set of sub-items, wherein the second selection comprises a selection of one or more additional products by a user associated with the user terminal;
obtain first cost information and second cost information in response to the second selection, wherein the first cost information and the second cost information are based on the plurality of values for the set of sub-items, the first cost information associated with a first payment method format and comprising a base cost of the item, the second cost information associated with a second payment method format and comprising an additional cost associated with the item, wherein the second cost information further comprises a cost associated with the one or more additional products, wherein the second payment method format is different from the first payment method format, and wherein the first cost information is based on the first selection and the second selection;
obtain, from the user terminal, payment method information indicating a third payment method format, wherein the third payment method format is different from the first payment method format and the second payment method format; and
cause the display of the user terminal to display the first cost information and the second cost information according to the third payment method format based on the payment method information.

15. A computing apparatus for providing item sales information, comprising:
a transceiver;
a memory comprising instructions; and
a processor, wherein the processor is connected to the transceiver and the memory to:
acquire a first selection of an item from a plurality of items, wherein the item is associated with a plurality of attributes;
acquire sub-item information associated with the item in response to the first selection, the sub-item information identifying a set of sub-items associated with the plurality of attributes of the item, wherein each item of the plurality of items is associated with a particular set of sub-items of a plurality of sets of sub-items;
cause a display of a user terminal to display the sub-item information;
acquire a second selection of a plurality of values for the set of sub-items, wherein the second selection comprises a selection of one or more additional products by a user associated with the user terminal;
obtain first cost information and second cost information in response to the second selection, wherein the first cost information and the second cost information are based on the plurality of values for the set of sub-items, the first cost information associated with a first payment method format and comprising a base cost of the item, the second cost information comprises associated with a second payment method format and comprising an additional cost associated with the item, wherein the second cost information further comprises a cost associated with the one or more additional products, wherein the second payment method format is different from the first payment method format, and wherein the first cost information is based on the first selection and the second selection;
obtain, from the user terminal, payment method information indicating a third payment method format, wherein the third payment method format is different from the first payment method format and the second payment method format; and
cause the display of the user terminal to display the first cost information and the second cost information according to the third payment method format based on the payment method information.
